(19) United States
(12) Patent Application Publication
(10) Pub. No.: US 2025/0192499 A1
(43) Pub. Date: Jun. 12, 2025

(54) CONTACT INSERT HAVING A BRIDGING FUNCTION FOR AN INDUSTRIAL ELECTRICAL CONNECTOR

(71) Applicant: HARTING ELECTRIC STIFTUNG & CO. KG, Espelkamp (DE)

(72) Inventors: Julie RUTTER, Elgin, IL (US); Markus WITTPAHL, Hüllhorst (DE); Wade FOURNIER, Elgin, IL (US); Jeffrey PAWLICKI, Elgin, IL (US)

(21) Appl. No.: 18/843,899

(22) PCT Filed: Feb. 20, 2023
(86) PCT No.: PCT/DE2023/100137

§ 371 Date: Sep. 4, 2024

(30) Foreign Application Priority Data
Mar. 8, 2022 (DE) 10 2022 105 337.7

(51) Int. Cl. H01R 31/08

(52) U.S. Cl. CPC H01R 31/08

(57) ABSTRACT

A contact insert for an industrial electrical connector is provided. The contact insert has a connection side for the connection of individual conductors of a multi-core cable and a contact side for electrical connection to a mating electrical connector or to a socket. The contact insert includes a bridging element, which has a connection region associated with the connection side, for electrical connection to a conductor of the multi-core cable, and at least two contact regions associated with the contact side, for each electrically contacting a mating contact element of a mating electrical connector or of a socket.

### BACKGROUND

### Technical Field

The present disclosure relates to a contact insert having a bridging function for an industrial electrical connector.

Such contact inserts are needed when the currents of individual conductors of a multi-core cable within the electrical connector must be divided. This can be the case in data centers, for example. In this case, the neutral conductor of a connected cable within a data rack may be divided between the individual server units of the data rack.

### Description of the Related Art

The document DE 20 2007 017 892 U1 discloses a contact insert for industrial electrical connectors having a PE (“Protective Earth”) plate.

If bridging of individual conductors is necessary for specific applications, the conductors have until now been bridged within the electrical connector housing. For this purpose, there must be sufficient space, and a correspondingly sized housing must be selected. Bridging within the housing harbors a high hazard potential. If the mechanical connection of the bridged conductors does not hold, live conductors can touch the electrical connector housing.

The German Patent and Trade Mark Office has searched the following prior art in the priority application for the present application: U.S. Pat. No. 3,421,134 A, JP H10-199643 A, DE 20 2005 020 026 U1 and DE 10 2010 011 371 A1.

### BRIEF SUMMARY

Embodiments of the present disclosure provide a contact insert for industrial electrical connectors that is safe, has a compact structure and can be connected conveniently to a cable.

The contact insert described herein is intended for use in a heavy industrial electrical connector. For this purpose, the contact insert is connected to a multi-core cable and screwed into an electrical connector housing or an attachment housing, also referred to as a socket.

The contact insert has a connection side for the connection of individual conductors of the multi-core cable. For this purpose, connection openings are provided on the connection side of the contact insert, into which connection openings the respective conductors of the multi-core cable can be inserted.

The contact insert has a contact side, which is used for electrical connection to a mating electrical connector or to a socket. For this purpose, the contact insert has contact openings on the contact side for the access of a mating contact element of a mating electrical connector or a socket.

In one embodiment, the contact insert may have n connection openings or connection regions and m contact openings or contact regions, wherein n and m are natural numbers, and number m is greater than number n.

In one embodiment of the present disclosure, the contact insert may have exactly one connection region (n=1) and exactly three contact regions (m=3).

In one embodiment, the contact insert may have a bridging element with a connection region associated with the connection side. A conductor of the multi-core cable is connected to the connection region. The bridging element also comprises at least two contact regions associated with the contact side. The contact regions are provided for in each case electrically contacting a mating contacting element of a mating electrical connector or a socket (or with the contact elements thereof). By using this bridging element, electrical bridging (also referred to as potential splitting) of a conductor of the cable can be designed flexibly. The bridging element is likewise very compact and therefore permits a compact design of the contact insert that is flat, as seen in the insertion direction.

In one embodiment, the connection region of the bridging element may be designed as a crimp barrel. This type of connection technology has proven reliable and is suitable in the present bridging situation.

It can be advantageous when the connection region is designed with a clamping spring as a so-called push-in connection. A corresponding electrical connector could thereby be assembled more rapidly, such as without tools.

Advantageously, the contact region of the bridging element is designed as a socket. The touch protection of the electrical connector is thereby improved.

In one embodiment, the bridging element may have a metal bar. The connection region (AB) and the contact regions (KB) may be arranged on the metal bar.

It is advantageous when the metal bar is substantially E-shaped. Thanks to the E-shape, it can be simply inlaid in the plastic body of the contact insert and allows for a compact design. For this purpose, the plastic body may be designed in two parts with a latching function of the two parts. Alternatively, the E-shaped bar, along with the connection region and contact regions, may be inlaid in an injection mold.

In one embodiment, the metal bar may be flat. In this case, flat means that the metal bar (without connection region and contact regions) can be laid with both sides on a plane, for example, and rests on this plane over virtually its entire area. In the installed state, one flat side of the metal bar is then oriented parallel to the connection side, and the other flat side is oriented parallel to the contact side of the contact insert.

In one embodiment, the connection region and the contact regions may be riveted on the metal bar. This type of fastening has proven particularly stable and advantageous in manufacturing terms.

As described above, the metal bar advantageously has an E-shape. In one embodiment, the contact regions may each be arranged on the ends of the horizontal strokes of the E of the metal bar. It is further advantageous when the connection region is arranged on the end of one horizontal stroke of the E of the metal bar. In this case, the connection region and the contact region protrude from the metal bar vertically but in opposite directions.

### BRIEF DESCRIPTION OF THE SEVERAL VIEWS OF THE DRAWINGS

An embodiment of the present disclosure is shown in the drawings and explained in more detail below.

FIG. 1 shows a perspective, partially cut-away and incomplete diagram of a contact insert.

FIG. 2 shows a perspective diagram of a bridging element that is used in the contact insert. FIG. 3 shows a sectional diagram of the contact insert.

The figures may contain in some cases simplified, schematic diagrams. Identical reference signs are sometimes used for like but possibly non-identical elements. Different views of like elements might be scaled differently. Direction information such as “left,” “right,” “top,” and “bottom” are to be understood with reference to the figure in question and can vary in the individual diagrams relative to the object represented.

### DETAILED DESCRIPTION

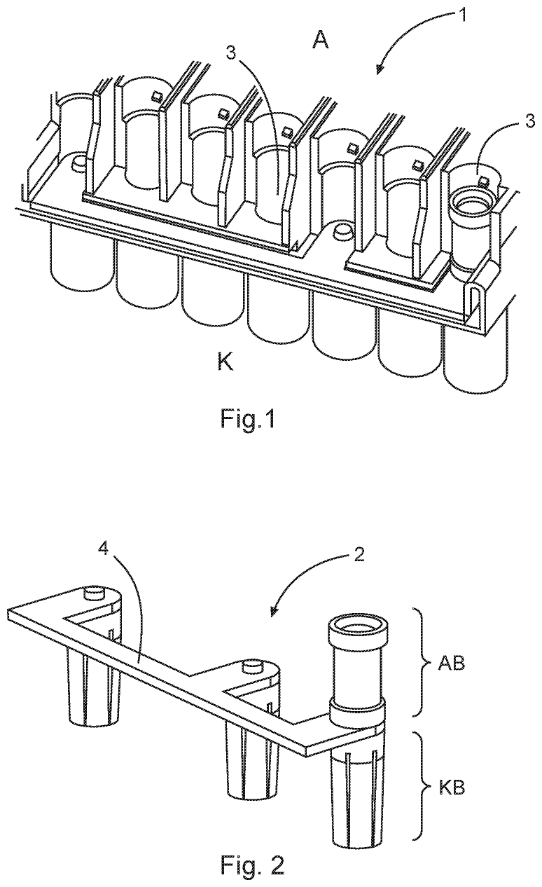

FIG. 1 shows a partially cut-away diagram of a contact insert 1. The diagram in FIG. 1 is incomplete, since only a part of the plastic housing and no further contact elements are shown apart from the bridging element. The contact insert 1 is intended specifically for use in industrial electrical connectors (not shown). Industrial electrical connectors are often used in harsh industrial environments.

The contact insert 1 has a connection side A. On the connection side A, individual conductors of a multi-core cable (not shown) are connected to the contact insert 1. The contact insert 1 has a contact side K, which is used for electrical connection to or contacting with a mating electrical connector or a socket.

The contact insert 1 consists of a plastic housing, in an interior of which a bridging element 2 is arranged. The bridging element 2 has a connection region AB on the connection side, which connection region is designed as a crimp barrel in the embodiment shown here. The connection region AB of the bridging element 2 is associated with the connection side A of the contact insert 1. The plastic housing of the contact insert 2 has contact chambers 3, in which the connection region AB of the bridging element 2 is arranged on the connection side. The conductor of the multi-core cable is inserted into such a contact chamber 3 on the connection side.

Contact regions KB of the bridging element 2 are each arranged in one contact chamber 3 on the contact side K, which cannot be seen in FIG. 1 from the perspective shown. In this embodiment, each contact region KB is designed as a socket contact. The socket contact is suitable for receiving a fitting contact pin and is used in each case for electrically contacting a mating contact element of a mating electrical connector or socket.

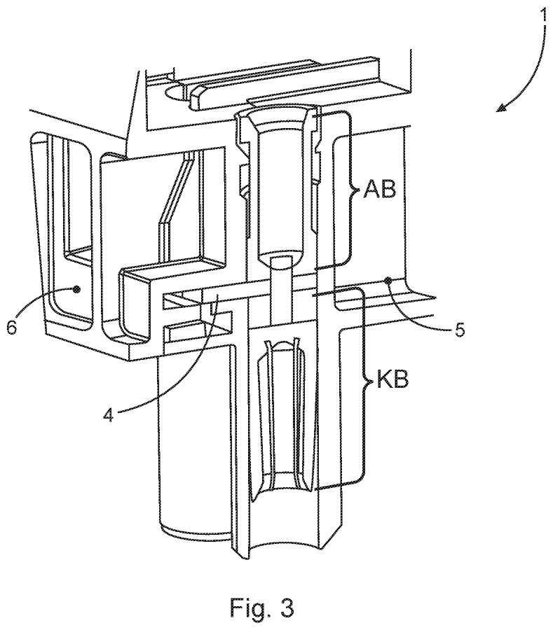

FIG. 2 shows a perspective view of the bridging element 2. The bridging element 2 has a metal bar 4. The metal bar 4 is a flat sheet metal part that is between one millimeter and 4 millimeters thick and is punched out of a correspondingly sized piece of sheet metal.

The metal bar 4 is substantially E-shaped. In FIG. 2, the metal bar 4 viewed in isolation looks like an E tilted to the left. The horizontal strokes of the E are parallel to one another but do not have the same distance from one another. The distance from the lower horizontal stroke of the E to the middle horizontal stroke of the E is smaller than the distance from the upper horizontal stroke of the E to the middle horizontal stroke of the E.

The contact regions KB are in each case riveted in an axially protruding manner to the E-shaped metal bar 4 on the contact side at the ends of the horizontal strokes of the E. On the connection side, the connection region AB is riveted to the end of the lower horizontal stroke of the E.

FIG. 3 shows a sectional diagram of the contact insert 1 described herein. The contact insert 1 has a two-part plastic housing, wherein the bridging element 2 is inserted into a first plastic housing part 5. The bridging element 2 is held captively in the plastic housing of the contact insert 1 by latching of the first plastic housing part 5 with a second plastic housing part 6.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A contact insert for an industrial electrical connector, comprising:
a connection side for a connection of individual conductors of a multi-core cable;
a contact side for electrical connection to a mating electrical connector or to a socket; and
a bridging element, which has a connection region associated with the connection side, for electrical connection to a conductor of the multi-core cable, and at least two contact regions associated with the contact side, for in each case electrically contacting a respective mating contact element of the mating electrical connector or the socket.

2. The contact insert as claimed in claim 1, wherein the connection region of the bridging element is designed as a crimp barrel.

3. The contact insert as claimed in claim 1, wherein the contact region of the bridging element is in each case designed as a socket.

4. The contact insert as claimed in claim 1, wherein the bridging element has a metal bar on which the connection region and the contact regions are arranged.

5. The contact insert as claimed in claim 4, wherein the metal bar is substantially E-shaped.

6. The contact insert as claimed in claim 4, wherein the metal bar is flat and that one flat side is oriented parallel to the connection side, and the other flat side is oriented parallel to the contact side.

7. The contact insert as claimed in claim 4, wherein the connection region and the contact regions are riveted on the metal bar.

8. The contact insert as claimed in claim 5, wherein the contact regions are each arranged on ends of horizontal strokes of the E of the metal bar.

9. The contact insert as claimed in claim 5, wherein the connection region is arranged on the end of one horizontal stroke of the E of the metal bar.

10. The contact insert as claimed in claim 1, wherein the contact insert has a two-part plastic housing, wherein the bridging element is inserted into a first plastic housing part and held captively in the plastic housing of the contact insert by latching of the first plastic housing part to a second plastic housing part.

11. The contact insert as claimed in claim 1, wherein the connection region has a clamping spring and is designed as a push-in connection.
